(19) United States
(12) Patent Application Publication
(10) Pub. No.: US 2010/0308707 A1
(43) Pub. Date: Dec. 9, 2010

(54) LED MODULE AND METHOD OF FABRICATION THEREOF

(75) Inventors: CHIN-LONG KU, Tu-Cheng (TW); QING-HAI RUAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/534,804

(22) Filed: Aug. 3, 2009

(30) Foreign Application Priority Data
Jun. 9, 2009 (CN) 200910303097.2

(51) Int. Cl. H01J 7/24; H01J 9/00

(52) U.S. Cl. 313/46; 445/23

(57) ABSTRACT

An LED module includes a heat dissipating device and an LED mounted on the heat dissipating device. The heat dissipating device includes a connecting surface. An insulating layer is deposited on the connecting surface of the heat dissipating device through vacuum sputtering, vaporization or anodizing. A circuitry is formed on the insulating layer. The LED is packaged on the circuitry and electronically connects with the circuitry.

### BACKGROUND

1. Technical Field

The disclosure relates to LED modules and, more particularly, to an LED module with improved heat dissipation ability so that heat generated by LEDs of the LED module can be effectively removed.

2. Description of Related Art

Generally, an LED module includes a plurality of LEDs mounted on and electronically connected with a printed circuit board (PCB). A heat sink made of metal, such as aluminum or copper, is arranged under the PCB to remove heat generated by the LEDs. To reduce thermal resistance between the heat sink and the PCB, thermal interface material, such as thermal grease, is often applied between the heat sink and the PCB. However, the thermal grease has a heat transfer coefficient generally not larger than 5 W/(m·K), which is much smaller than that of the metal. Furthermore, as the PCB is made of FR-4, which is produced by glass fiber impregnation into ethoxyline, thermal resistance of the PCB is very large. Heat generated by the LEDs is only very slowly transferred to the heat sink through the PCB and the thermal grease. Heat thus cannot be rapidly and efficiently removed, which results in significant reductions in the lifespan of the LEDs.

Therefore, it is desirable to provide an LED module wherein one or more of the foregoing disadvantages may be overcome or at least alleviated.

### BRIEF DESCRIPTION OF THE DRAWINGS

FIG. 1 is a front, schematic view of an LED module in accordance with an embodiment of the present disclosure.

FIG. 2 is a top view of the LED module of FIG. 1;

FIG. 3 is a view similar to FIG. 2, in which LEDs are removed to show circuitry of the LED module of FIG. 1.

### DETAILED DESCRIPTION

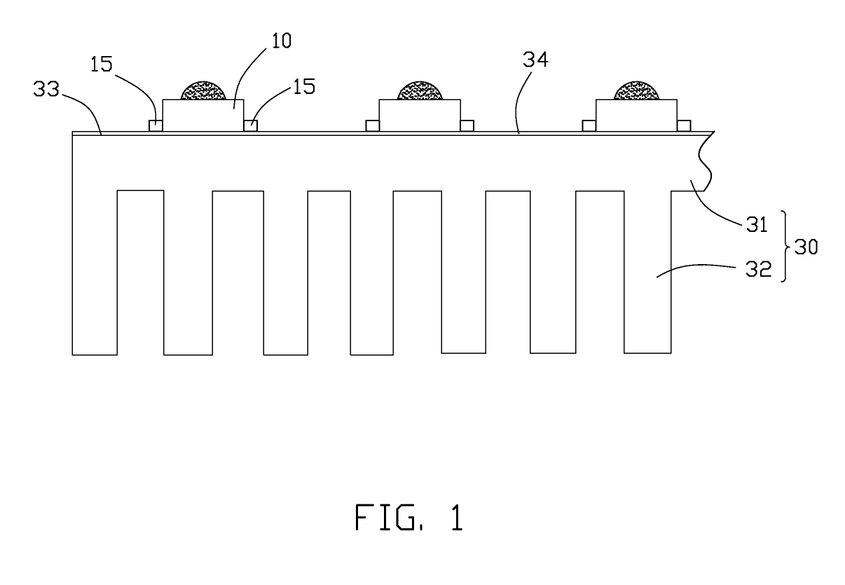

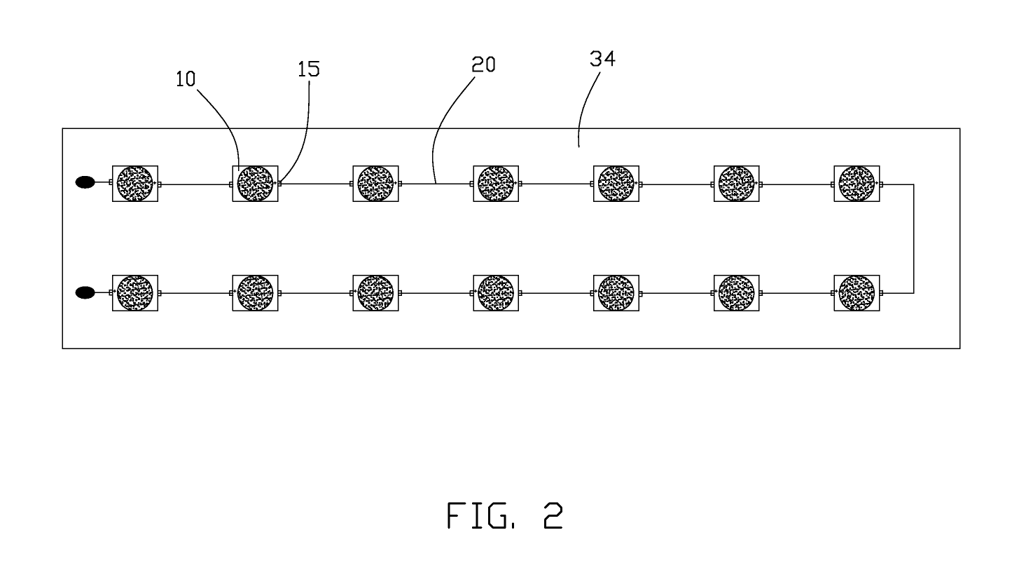

Referring to FIGS. 1-2, an embodiment of an LED module comprises a heat sink 30 and a number of LEDs 10 mounted on a side of the heat sink 30. The heat sink 30 dissipates heat generated by the LEDs 10.

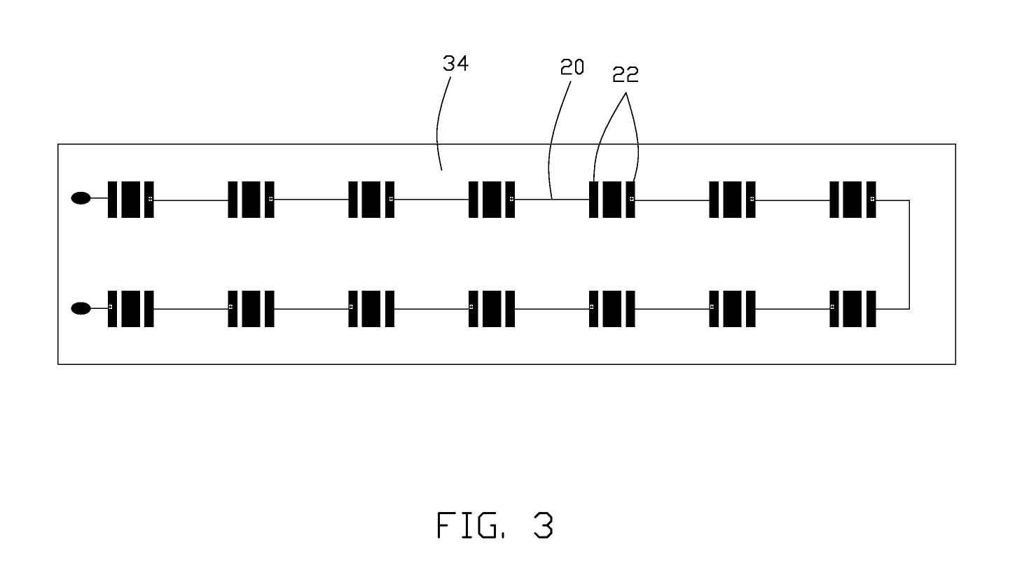

Referring to FIG. 3 also, in this embodiment, the heat sink 30 is made of highly thermally conductive material, such as copper, aluminum, or their alloys. The heat sink 30 as shown in this embodiment is an extruded aluminum heat sink, and includes a rectangular base 31 and a number of fins 32 extending downwardly from a bottom surface of the base 31. The fins 32 are used for increasing a heat dissipation area of the heat sink 30. A top surface of the base 31 is flat and forms a connecting surface 33 for the LEDs 10 to be mounted thereon. An insulating layer 34 is formed on a top of connecting surface 33 of the heat sink 30 by a known method. For example, the insulating layer 34 is deposited on the connecting surface 33 of the heat sink 30 through vacuum sputtering, vaporization or anodizing. Thus, a firm bonding relationship exists between the insulating layer 34 and the connecting surface 33 of the heat sink 30. The insulating layer 34 is a highly thermally conductive. A thickness of the insulating layer 34 is varied between 40 and 150 μm. A circuitry 20 is formed on a top surface of the insulating layer 34 by a copper foil layer which is formed through electroless copper deposition or electrodeposition. Then the copper foil layer is subject to photoresist coating, exposing and etching, to thereby form the circuitry 20. The circuitry 20 has a number of pads 22 to electronically connect with lead pins 15 of the LEDs 10. The LEDs 10 are mounted on the circuitry 20 by packaging. The lead pins 15 of the LEDs 10 electronically connect with the pads 22 of the circuitry 20. It is to be understood that the circuitry 20 is formed according to the number and arrangement of the LEDs 10.

The circuitry 20 is directly formed on the insulating layer 34 of the base 31 of the heat sink 30 and the LEDs 10 are mounted on the circuitry 20. Thus, the heat resistance formed either between the LEDs 10 and the printed circuit board (PCB), or between the PCB and the heat sink 30 of a conventional LED module is thus avoided. During operation, heat generated by the LEDs 10 can be timely transferred to the base 31, and then dissipated to ambient air through the fins 32 rapidly and efficiently. In this way, heat of the LEDs 10 can be quickly removed, thus significantly improving lifespan of the LEDs 10.

A method in accordance with the present invention for producing the LED module comprises following steps. Firstly, a heat sink 30 is provided. In this embodiment, the heat sink 30 comprises a rectangular base 31 and a plurality of fins 32 extending downwardly from a bottom surface of the base 31. A top surface of the base 31 is flat and forms a connecting surface 33 which is processed with cleaning, caustic scrubbing or deburring so that the connecting surface 33 can be firmly attached with an insulating layer 34. A thickness of the insulating layer 34 is varied between 40 and 150 μm. The insulating layer 34 is deposited on the connecting surface 33 of the heat sink 30 through vacuum sputtering, vaporization or anodizing.

A circuitry 20 is then formed on the insulating layer 34 by the following steps. Firstly, a thin layer of copper foil is applied onto a top surface of the insulating layer 34 so as to evenly cover the insulating layer 34. The copper foil layer can be formed on the insulating layer through electroless copper deposition, or electrodeposition. As metallic material does not easily adhere to the insulating layer 34, surface activation is usually needed before forming the copper foil layer on the insulating layer 34. The surface activation usually includes silver spraying and sandblasting. The copper foil layer is easily applied to the insulating layer 34 after the surface activation. Then the circuitry 20 is formed on the top surface of the insulating layer 34 by the copper foil layer through photoresist coating, exposing and etching.

The LEDs 10 now can be packaged onto the circuitry 20 to form the LED module. The LEDs 10 are packaged on the circuitry 20 and lead pins 15 thereof electronically connect with the pads 22 of the circuitry 20 through wire bonding. Therefore, the LED module is formed.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED (light emitting diode) module comprising:
a heat dissipating device comprising a connecting surface;
an insulating layer deposited on the connecting surface of the heat dissipating device through one of vacuum sputtering, vaporization and anodizing;
a circuitry formed on the insulating layer; and
a plurality of LEDs secured to the heat dissipating device and electrically connected with the circuitry.

2. The LED module as claimed in claim 1, wherein the heat dissipation device is a metallic base, and the connecting surface is formed on a top side of thereof.

3. The LED module as claimed in claim 2, wherein a number of fins formed on a bottom side of the base to dissipate heat absorbed by the base.

4. The LED module as claimed in claim 1, wherein the circuitry has a number of pads to electronically connect with lead pins of the LEDs.

5. The LED module as claimed in claim 1, wherein the plurality of LEDs are mounted on the circuitry and electronically contact with the circuitry.

6. The LED module as claimed in claim 1, wherein the insulating layer is highly thermally conductive.

7. The LED module as claimed in claim 1, wherein a thickness of the insulating layer is varied between 40 and 150 μm.

8. A method for manufacturing an LED module comprising:
providing a heat dissipating device having a connecting surface for an LED to be mounted thereon;
insulating the connecting surface of the heat dissipation device by applying an insulating layer to the connecting surface;
forming a circuitry on the insulating layer; and
attaching the LED to the circuitry and connecting the LED with the circuitry electrically.

9. The method in claim 8, wherein the insulating layer is deposited on the connecting surface of the heat dissipating device through one of vacuum sputtering, vaporization and anodizing.

10. The method in claim 8, wherein the circuitry is formed on the insulating layer by firstly covering the insulating layer with a copper foil layer thereon through one of the following methods: electroless copper deposition and electrodeposition, and then photoresist coating, exposing and etching the copper foil layer.

11. The method in claim 10 further comprising a step of surface activation before forming the circuitry, the surface activation being one of the following methods: silver spraying and sandblast.

12. The method in claim 8, wherein the heat dissipation device is a fin-type heat sink which comprises a base and a plurality of fins extending downwardly from a bottom surface of the base and the connecting surface is a top surface of the base.
